(19) United States
(12) Patent Application Publication
(10) Pub. No.: US 2010/0215807 A1
(43) Pub. Date: Aug. 26, 2010

(54) UNCOOKED AND FORTIFIED FOOD COMPOSITION

(76) Inventor: William Franklin, Shepherd, TX (US)

Correspondence Address: JAY M. SCHLOFF, 6960 Orchard Lake Road, Suite 315, West Bloomfield, MI, 48322, US

(21) Appl. No.: 12/392,269

(22) Filed: Feb. 25, 2009

(51) Int. Cl. A23L 1/30; B65D 85/72; A23L 1/302; A23L 1/303; A23L 1/304; A23L 1/305

(52) U.S. Cl. 426/73; 426/72

(57) ABSTRACT

Disclosed is a nutritional food package that includes an uncooked and a fortified food composition, and an enclosure for storing the food composition. The food composition includes non-animal proteins in an amount of about 10.59 percent by weight of total weight of the food composition, non-wheat carbohydrates in an amount of about 63.56 percent by weight of the total weight of the food composition, vitamins, and minerals and trace elements.

### FIELD OF THE INVENTION

The present invention relates generally to a food composition, and more specifically, to an uncooked and a fortified food composition.

### BACKGROUND OF THE INVENTION

With an increase in the level of awareness about balanced diets as spread by dieticians as well as by general public, maintenance of a healthy diet has become a primary concern for many individuals. However, with today's accelerated pace of living, it has become increasingly difficult for an ordinary individual to find time to prepare nutritious meals ensuring a daily intake of nourishment essential for his or her body. At times, the individual may even skip an entire important meal, such as his or her breakfast due to lack of time. Due to lack of time, such an individual tends to prepare and consume fast food alternatives, which are often either fattening or have an inadequate nutritive value.

Consequently, a large segment of human population has indulged into a habit of consuming food supplements that are readily available in the market, in order to compensate deficiencies in daily diet. The purpose of these food supplements is to provide an individual with a daily dosage of essential food nutrients, which are often lacking in an ordinary meal and/ or fast food alternatives.

Such food supplements also include uncooked food supplements, which are readily available in the market. However, these food supplements may contain wheat, nuts, possibly dried fruit, and other such ingredients, and accordingly, are characterized to have an increased fat content. Further, to provide an acceptable amount of nutrition, the food supplements may contain relatively large amounts of proteins in addition to significant amounts of simple and complex carbohydrates. More specifically, the food supplements may include ingredients/nutrients that are obtained from an animal source and/or a dairy product. However, because many such ingredients/nutrients have objectionable flavor, a serious problem may exist while achieving both the high protein content and an appealing flavor of the food supplements. Further, such food supplements with animal proteins and/or dairy products are not at all consumed by people who either follow certain religious beliefs or are vegetarian. Also, consumption of many of the food supplements that specifically include dairy/milk products in a high amount may lead to lactose intolerance in an individual.

Furthermore, most of the food supplements that are known in the art are often suggested as a nutritional addition or supplement to a regular diet, and accordingly, an individual may not completely rely on consumption of such food supplements for providing sustained energy as opposed to a complete nutritional meal.

Additionally, most of the readily available food supplements are in fact intended to be used only until a specific purpose is achieved. Suitable examples of such food supplements consumed for a specific purpose may include, but are not limited to, supplements consumed during weight reduction/slimming activity, supplements consumed for muscle building, and nutrient solutions consumed by a patient suffering from a specific disease. Because of the intended short time usage, the food supplements are more often focused on solving an immediate problem and are thus not suitable for a long-term nutritional supply to a human body. Moreover, most of the food supplements are expensive, and accordingly, not affordable by a large segment of population. In addition, most of the food supplements that are known in the art are not properly and effectively packaged for an enhanced ease of use by a consumer.

Accordingly, there is a need for a fortified food composition that is capable of providing sustained energy to a consumer. Further, the food composition should be an uncooked food composition that is scrumptious and ready-to-consume, and has a fair market value. Furthermore, the food composition should be capable of substituting a complete meal. Additionally, the food composition should be available in a proper packaged form for an enhanced ease of use by the consumer.

### SUMMARY OF THE INVENTION

In view of the foregoing disadvantages inherent in the prior art, the general purpose of the present invention is to provide an uncooked and a fortified food composition, which includes all the advantages of the prior art, and overcomes the drawbacks inherent therein.

Accordingly, an object of the present invention is to provide an uncooked and a fortified food composition that is capable of providing sustained energy to a consumer.

Another object of the present invention is to provide an uncooked and a fortified food composition that is scrumptious and ready-to-consume, and has a fair market value.

Still another object of the present invention is to provide an uncooked and a fortified food composition that is capable of substituting a complete meal.

Yet another object of the present invention is to provide an uncooked and a fortified food composition that is capable of being properly packaged for an ease of use by a consumer.

In light of the above objects, the present invention discloses a nutritional food package that meets percent daily values of nutritional content based on a 2,000 calorie diet. Further, the nutritional food package may be utilized by children, having an age equal to or more than about 4 years, and by adults. Specifically, the nutritional food package includes an uncooked and a fortified food composition for providing sustained energy to a consumer. The food composition comprises non-animal proteins in an amount of about 10.59 percent by weight of total weight of the food composition; non-wheat carbohydrates in an amount of about 63.56 percent by weight of the total weight of the food composition; vitamins; and, minerals and trace elements. The nutritional food package further comprises an enclosure for storing the food composition.

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a nutritional food package including a food composition, in the form of a beverage, and a bottle for storing the food composition, according to an embodiment of the present invention;

FIG. 2 illustrates a perspective view of a nutritional food package including a food composition, in the form of a beverage, and a can for storing the food composition, according to another embodiment of the present invention;

FIG. 3 illustrates a perspective view of a nutritional food package including a food composition, in the form of a beverage, and a drink box for storing the food composition, according to still another embodiment of the present invention; and

FIG. 4 illustrates a perspective view of a nutritional food package including a food composition, in the form of a food bar, and an enclosure for storing the food composition, according to yet another embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a,” and “an,” herein do not denote a limitation of quantity, but rather denote the presence of at least one of the referenced item. The use of “including,” “comprising,” or “having” and variations thereof herein is meant to encompass the items listed thereafter and equivalents thereof as well as additional items.

The term “nutrition” refers to a process/series of processes by which humans obtain energy in the form of food for growth, maintenance and repair. The term “food” refers to a material containing nutrients such as carbohydrates, proteins, vitamins, minerals and trace elements, optionally fats and amino acids, which are required and consumed by humans in order to obtain energy. An “uncooked food composition” is a food composition that may either be in the form of a food bar or a beverage that is ready-to-use for a quick consumption. The ingredients are selected such that baking or cooking of the ingredients is not required. More specifically, the uncooked food composition is not required to be cooked and baked.

The term “sustained energy” is defined as a lack of hunger or a feeling of fullness (satiety) particularly for a time of up to two hours.

The present invention provides a nutritional food package for providing sustained energy to a consumer. The nutritional food package comprises an uncooked and a fortified food composition, and an enclosure for storing the food composition. The food composition of the present invention follows standard nutritional guidelines as set according to percent daily values of nutritional content. Further, the percent daily values of nutrients of the food composition are based on a 2000 calorie diet. Specifically, the food composition includes a blend of proteins, carbohydrates, vitamins, minerals and trace elements.

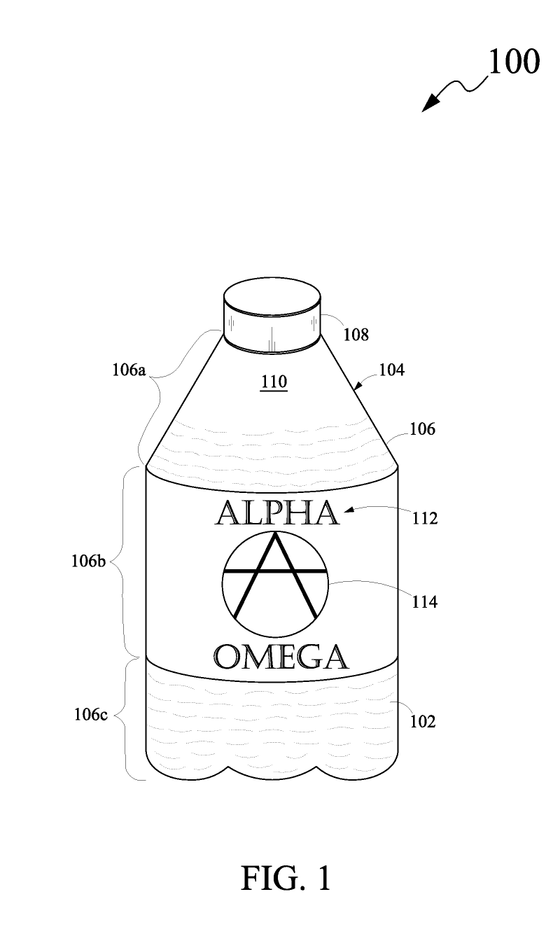

According to an aspect of the present invention, the food composition, which is prepared in the form of a beverage may be packaged and stored in an enclosure, such as a bottle, a can, and a drink box. FIGS. 1, 2 and 3, illustrate various embodiments of the nutritional food package that includes the food composition, which is in the form of the beverage.

FIG. 1 illustrates a perspective view of a nutritional food package 100 that includes a food composition 102, in the form of a beverage, and a bottle 104 for storing the food composition 102, according to an embodiment of the present invention.

The food composition 102 includes non-animal proteins. Specifically, the food composition 102 may include at least one ingredient for providing the non-animal proteins. It should be understood that the term, “proteins,” as used herein, may refer to one or more proteins. Further, the term “non-animal proteins,” as used herein, refers to non-animal proteins, non-dairy proteins and non-milk proteins. Suitable examples of the at least one ingredient that includes the non-animal proteins include, but are not limited to, soy and rapeseed. Accordingly, the non-animal proteins may comprise one or more soy proteins. Alternately, the non-animal proteins may comprise one or more rapeseed proteins. However, it should be understood that the non-animal proteins may comprise one or more soy proteins with one or more rapeseed proteins.

It should be apparent to a person skilled in the art that the non-animal proteins may be added as protein isolates, such as a soy protein isolate, or may be sourced from ingredients, such as soy beans or rapeseed, or may be a mixture of both. The food composition 102 provides 100 percent of daily values of proteins to the consumer. More specifically, the food composition 102 includes 50 grams (g) of the non-animal proteins to provide 100 percent of the daily values of the proteins to the consumer. Even more specifically, the food composition 102 includes the non-animal proteins at an amount of about 10.59 percent by weight of total weight of the food composition 102. The term “percent by weight,” as used herein refers to the percent by weight of a nutrient with respect to total weight of the food composition 102, which is about 471.95 grams.

As disclosed above, proteins employed in the food composition 102 are non-animal proteins and/or non-dairy proteins, and accordingly, the food composition 102 may be consumed by people who either follow austere religious beliefs or are vegetarian.

Further, the food composition 102 includes a total fat content, which is less than percent daily values of fats. More specifically, the food composition 102 includes about 64 g of total fats to provide 98.46 percent of the daily values of the fats. Additionally, the food composition 102 includes about 19 g of saturated fatty acids to provide 95 percent of the daily values of saturated fatty acids. Moreover, the food composition 102 includes about 1.90 g of trans fats to provide 95 percent of daily values of trans fats to the consumer. In addition, the food composition 102 includes about 290 milligrams (mg) of cholesterol to provide about 96.67 percent of daily values of cholesterol to the consumer.

Specifically, the food composition 102 includes total fat at an amount of about 13.56 percent by weight, saturated fatty acids at an amount of about 4.025 percent by weight, cholesterol at an amount of about 0.061 percent by weight, and trans fats at an amount of about 0.402 percent by weight.

The food composition 102 further includes non-wheat carbohydrates in an amount of about 63.56 percent by weight of the total weight of the food composition 102. Specifically, the food composition 102 includes at least one ingredient for providing the non-wheat carbohydrates. The non-wheat carbohydrates comprise at least one of simple carbohydrates and complex carbohydrates. It should be understood that the term, “carbohydrates,” as used herein, may refer to one or more carbohydrates.

Preferably, the at least one ingredient for providing the non-wheat carbohydrates is rice. The simple carbohydrates are selected from the group consisting of monosaccharides, disaccharides, and combinations thereof. Specifically, each simple carbohydrate is at least one of glucose, fructose, sucrose, galactose, maltose and dextrose. However, the food composition 102 is free from lactose in order to prevent occurrence of allergic reactions caused by lactose intolerance in the consumer. For the foregoing reason, it should be understood that the food composition 102 is devoid of any animal/dairy product, which usually includes lactose. The complex carbohydrates are selected from the group consisting of oligosaccharides, polysaccharides, and combinations thereof. Specifically, a complex carbohydrate is at least one of starch and glycogen.

As disclosed above, the non-wheat carbohydrates are used in the food composition 102, as wheat includes gluten, and, a high amount of gluten when consumed may result in intolerance to the consumer. For the purpose of this description, rice is used as the source of carbohydrates as rice does not include gluten and is known to have low fat content than wheat. Furthermore, rice is known to be rich in proteins.

It should be understood that a blend of simple and complex carbohydrates contributes to a major portion of the sustained energy that is provided by the food composition 102 of the present invention. The food composition 102 of the present invention provides 100 percent of daily values of both simple and complex carbohydrates to the consumer. More specifically, the food composition 102 includes about 300 g to provide 100 percent of the daily values of carbohydrates to the consumer. Even more specifically, the food composition 102 includes non-wheat carbohydrates at an amount of about 63.56 percent by weight. Further, the food composition 102 may include dietary fiber. Specifically, the food composition 102 may include the dietary fiber at an amount of about 5.29 percent by weight.

The food composition 102 is free from nuts. Although the nuts are known to be a rich source of carbohydrates, however, a segment of consumer population has shown occurrence of allergic reactions post-utilizing food compositions that include nuts. In addition, the food composition 102 of the present invention is free from whey, which is milk plasma, and is known to be rich in lactose and fat.

In addition to the aforementioned nutrients, the food composition 102 also includes vitamins. The vitamins comprise at least one of vitamin A, vitamin B1, vitamin B2, vitamin B3, vitamin B6, vitamin B5, folate, vitamin B12, biotin, vitamin C, vitamin D, vitamin E and vitamin K. Further, the vitamins may include all of the B-type vitamins that are needed for energy metabolism.

Specifically, the food composition 102 includes vitamin A at an amount of about 0.0012 percent by weight, vitamin C at an amount of about 0.012 percent by weight, vitamin D at an amount of about 0.000002 percent by weight, vitamin E at an amount of about 0.004 percent by weight, vitamin K at an amount of about 0.00001 percent by weight, vitamin B1 at an amount of about 0.0003 percent by weight, vitamin B2 at an amount of about 0.0003 percent by weight, vitamin B3 at an amount of about 0.004 percent by weight, folate at an amount of about 0.00008 percent by weight, vitamin B6 at an amount of about 0.0004 percent by weight, vitamin B12 at an amount of about 0.000001, biotin at an amount of about 0.00006 percent by weight, and vitamin B5 at an amount of about 0.002 percent by weight.

Moreover, the food composition 102 includes minerals and trace elements. The minerals comprise at least one of calcium, phosphorus, magnesium, sodium, potassium, sulfur and chloride. The food composition 102 of the present invention provides 100 percent of daily values of both minerals and trace elements to the consumer. However, the food composition 102 includes about 2300 mg of sodium to provide about 95.83 percent of daily values of sodium to the consumer.

Specifically, the food composition 102 includes sodium at an amount of about 0.49 percent by weight, calcium at an amount of about 0.211 percent by weight, potassium at an amount of about 0.74 percent by weight, phosphorous at an amount of about 0.2 percent by weight, magnesium at an amount of about 0.084 percent by weight, and chloride at an amount of about 0.72 percent by weight.

A trace element is a chemical element that is needed in minute quantities for proper growth, development, and physiology of a human body. More specifically, a trace element is a micronutrient that is essential but needed in amounts of less than 100 mg per day. Further, the trace elements may also be referred to as microminerals. The trace elements include at least one of iron, cobalt, chromium, copper, iodine, manganese, selenium, zinc and molybdenum.

Specifically, the food composition 102 includes iron at an amount of about 0.003 percent by weight, iodine at an amount of about 0.00003 percent by weight, zinc at an amount of about 0.0031 percent by weight, selenium at an amount of about 0.000014 percent by weight, copper at an amount of about 0.0004 percent by weight, manganese at an amount of about 0.0004 percent by weight, chromium at an amount of about 0.00002 percent by weight, and molybdenum at an amount of about 0.000015 percent by weight.

The vitamins, minerals and trace elements do not add significantly to the total weight of the food composition 102, however, the food composition 102 of the present invention provides 100 percent of daily values of vitamins, minerals and trace elements to the consumer.

The food composition 102 may also comprise at least one ingredient comprising amino acids. The amino acids comprise at least one of glycine, serine, lysine, alanine, aspartic acid, glutamic acid, proline, arginine, hydroxyproline, phenylalanine, tryptophan, threonine, valine, isoleucine, histidine, leucine, tyrosine, methionine and modified forms thereof.

Methods that are known in the prior art may be used to prepare the food composition 102 of the present invention. More specifically, the food composition 102, which is in the form of a beverage, may be prepared by mixing ingredients comprising the aforementioned nutrients or by mixing isolates of the aforementioned nutrients with water depending on preferences of taste of the consumer. Subsequently, the uncooked and the fortified food composition 102 may be packaged in the bottle 104.

The food composition 102, in the beverage form, may be prepared in order to have a specific weight depending on respective weights of the nutrients of the food composition 102. Specifically, the food composition 102, in the beverage form, may be prepared in order to have a weight ranging from about 8 Fluid Ounces (239.99 grams) to about 15.732 Fluid Ounces (471.95 grams; 465.25 milliliters) depending on respective weights of the nutrients of the food composition 102.

The bottle 104 includes a container-like body 106 and a cap 108. The body 106 is capable of holding and storing the food composition 102. For the purpose of this description, the body 106 is shown to include three parts, 106a, 106b and 106c, as depicted in FIG. 1. It should be understood that the parts 106a-c differ in their respective average diameters/circumferences to configure a specific shape of the body 106. Preferably, the parts 106a, 106b and 106c have average diameters of about 2.51 inches, about 2.515 inches and about 2.53 inches, respectively.

Further, the bottle 104 may be made of a structurally strong, lightweight, attractive, stackable, and disposable material. More specifically, the bottle 104 may be made of a plastic material. Furthermore, the bottle 104 may be manufactured in standard or custom sizes and shapes in order to enclose a specific quantity of the food composition 102. Preferably, the bottle 104 is a 16.9 Fluid Ounce (Fl. Oz.) bottle, which is capable of holding a volume of about 500 milliliters (ml) of the food composition 102. Serving size may be 1000 ml, i.e., two such bottles 104, such that, each bottle 104 may include about 7.866 Fl. Oz. (232.629 ml) of a concentrate of the food composition 102 and about 9.034 Fl. Oz. (267.172 ml) of purified water in order to provide a 100 percent daily value. However, it should be understood that the bottle 104 may have a capacity greater than about 16.9 Fl. Oz.

Additionally, the bottle 104 may display or include various designs and figures on an outer surface 110. The outer surface 110 may include at least one of a label, a design and a logo to provide an aesthetic appearance to the nutritional food package 100. For the purpose of this description, the outer surface 110 includes a label 112, “ALPHA OMEGA,” imprinted thereon as a representation of the food composition 102. Alternatively, the outer surface 110 may include other labels that help identify contents and advantages of the food composition 102.

Further, the outer surface 110 includes a logo 114 imprinted thereon as a representation of the food composition 102. It should be noted that the bottle 104 may be manufactured to display various other designs made or imprinted on the outer surface 110 using different colors. Preferably, the outer surface 110 of the bottle 104 may be manufactured to have a metallic gold color on which the label 112 and the logo 114 may be represented using a red color.

The cap 108 of the bottle 104 may be opened for dispensing the food composition 102 from within the bottle 104 prior to consumption. Preferably, the cap 108 has a diameter of about 1.28 inches.

It should be apparent to a person skilled in the art that a plurality of nutritional food packages 100 may be encased together as a large pack. Preferably, 12 such nutritional food packages 100 may be encased together to form the large pack. Further, a single pack may include two such nutritional food packages 100 encased together. The encasing may be made of a structurally strong, lightweight, attractive, stackable, and disposable material. Suitable examples of such a material may include, but are not limited to, a paper material, a cardboard material, and a plastic material.

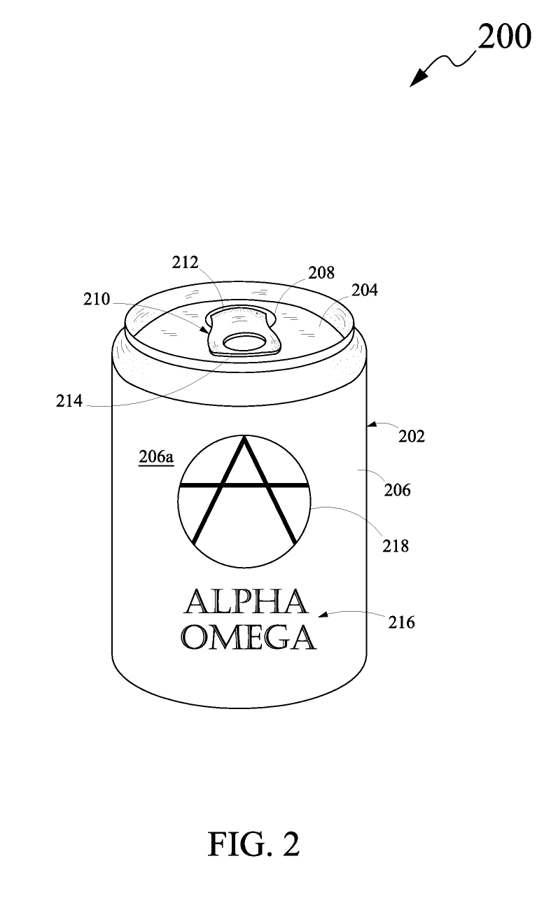

FIG. 2 illustrates a perspective view of a nutritional food package 200 that includes a food composition (not shown) and a can 202 for storing the food composition, according to another embodiment of the present invention. It should be understood that the food composition is in the form of a beverage and is similar to the food composition 102 in terms of composition with regard to proteins, carbohydrates, vitamins, minerals and trace elements.

The can 202 includes a retain tab top 204 and a sidewall 206. The retain tab top 204 forms a top portion of the can 202. Further, the retain tab top 204 includes a pouring section 208 and an opener tab 210. The pouring section 208 may easily be sealed during a packaging process, and further is an openable and a non-resealable section. Further, the pouring section 208 may be opened with the help of the opener tab 210, which is a rotatable tab. The opener tab 210 includes a breaking end 212 and a lifting end 214 configured opposite to the breaking end 212. Prior to opening the pouring section 208, a consumer may rotate the opener tab 210 in a specific direction. The consumer may then lift the lifting end 214 of the opener tab 210 causing the breaking end 212 to move downward, thereby puncturing the sealed pouring section 208. Subsequently, the food composition may easily be dispensed from within the can 202. Further, the food composition may directly be withdrawn either by inverting the can 202 in an upside down direction or by utilizing a straw to sip the food composition.

The sidewall 206 includes an inner surface (not shown) and an outer surface 206a. The outer surface 206a of the sidewall 206 may include various designs and figures thereon for providing aesthetic appearance or for providing information about contents of the food composition. Further, the outer surface 206a may include one or more labels for identifying the enclosed food composition. For the purpose of this description, the outer surface 206a includes a label 216, “ALPHA OMEGA,” imprinted thereon as a representation of the food composition. Alternatively, the outer surface 206a may include other labels that help identify contents and advantages of the food composition.

Further, the outer surface 206a includes a logo 218 imprinted thereon as a representation of the food composition. It should be noted that the can 202 may be manufactured to display various other designs made or imprinted on the outer surface 206a using different colors. Preferably, the outer surface 206a of the can 202 may be manufactured to have a metallic gold color on which the label 216 and the logo 218 may be represented using a red color.

It should be understood that the can 202, used for storing the food composition, may be manufactured in standard or custom sizes and shapes in order to enclose a specific quantity of the food composition. Preferably, the can 202 may have a diameter of about 2 inches and a length of about 6.0625 inches. Further, the can 202 is a 16 Fl. Oz. capacity can, which is capable of holding a volume of about 473 ml of the food composition. However, it should be understood that the can 202 may have a capacity greater than about 16 Fl. Oz.

Furthermore, the can 202 may be made of a structurally strong, lightweight, attractive, stackable, and disposable material. More specifically, the can 202 may be made of metals such as tin, aluminum, glass, plastic laminates, and composites of plastic and metal laminate.

It should be understood that the food composition may be stored within an enclosure that is then packaged as the can 202 using conventional canning techniques to form the nutritional food package 200. The packaging of the food composition as the nutritional food package 200 allows for providing a commercially sterile food composition, for providing nutritional benefits and marketing convenience, and for preventing recontamination of the food composition after canning or during subsequent transportation and storage.

Further, it should be apparent to a person skilled in the art that a plurality of nutritional food packages 200 may be encased together as a large pack. Preferably, 12 such nutritional food packages 200 may be encased together to form the large pack. Further, a single pack may include two such nutritional food packages 200 encased together. The encasing may be made of a structurally strong, lightweight, attractive, stackable, and disposable material. Suitable examples of such a material may include, but are not limited to, a paper material, a cardboard material, and a plastic material.

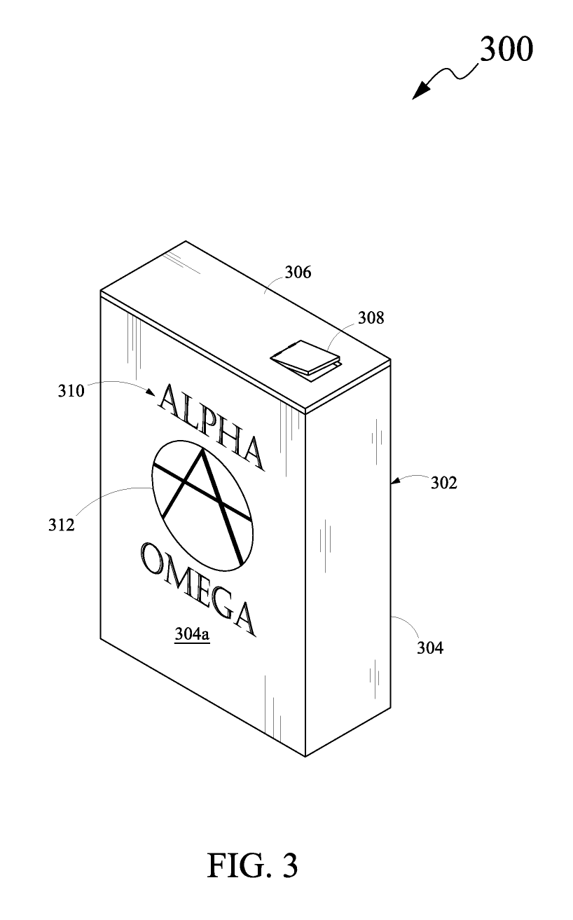

FIG. 3 illustrates a perspective view of a nutritional food package 300 that includes a food composition (not shown), in the form of a beverage, and a drink box 302 for storing the food composition, according to still another embodiment of the present invention. It should be understood that the food composition is in the form of a beverage and is similar to the food composition 102 in terms of composition with regard to proteins, carbohydrates, vitamins, minerals and trace elements.

The drink box 302 includes a container-like body 304, a top portion 306 and a flap portion 308 configured on the top portion 306. The body 304 is capable of holding and storing the food composition. The flap portion 308 is used for dispensing the food composition from within the body 304. The flap portion 308 may be manufactured in the form of a lid, which may easily be opened. Alternatively, the flap portion 308 may be a cap or a cork that may be opened for withdrawing the food composition from within the body 304. Further, a straw may be inserted through the flap portion 308 for drinking purposes. Without departing from the scope of the present invention, the nutritional food package 300 may be manufactured with a built-in straw.

The body 304 of the drink box 302 may include various designs and figures on an outer surface 304a for providing aesthetic appearance or for providing information about contents of the food composition. Further, the outer surface 304a may include at least one of a label, a design and a logo to provide an aesthetic appearance to the nutritional food package 300. For the purpose of this description, the outer surface 304a includes a label 310, “ALPHA OMEGA,” imprinted thereon as a representation of the food composition. Alternatively, the outer surface 304a may include other labels that help identify contents and advantages of the food composition.

Furthermore, the outer surface 304a includes a logo 312 imprinted thereon as a representation of the food composition. It should be understood that the logo 312 is similar to the logo 114 of FIG. 1 and the logo 218 of FIG. 2 in terms of design, shape and color. It should also be understood that the outer surface 304a may be designed in a similar manner as the outer surface 110 of FIG. 1 and the outer surface 206a of FIG. 2 in terms of aesthetic appearance. Preferably, the outer surface 304a of the body 304 may be manufactured to have a metallic gold color on which the label 310 and the logo 312 may be represented using a red color.

It should be understood that the drink box 302, used for storing the food composition, may be manufactured in standard or custom sizes and shapes in order to enclose a specific quantity of the food composition. Preferably, the drink box 302 may have a length of about 8.375 inches, a width of about 3.5 inches and a thickness of about 1.5 to about 2.5 inches. Further, the drink box 302 is a 16 Fl. Oz. capacity drink box, which is capable of holding a volume of about 473 ml of the food composition. However, it should be understood that the drink box 302 may be a drink box may have a capacity greater than about 16 Fl. Oz.

Furthermore, the drink box 302 may be made of a structurally strong, lightweight, attractive, stackable, and disposable material. More specifically, the drink box 302 is a metallic drink box, and accordingly, may be made of metals such as tin, aluminum, and composites of plastic and metal laminates.

It should be apparent to a person skilled in the art that a plurality of nutritional food packages 300 may be encased together as a large pack. Preferably, 12 such nutritional food packages 300 may be encased together to form the large pack. Further, a single pack may include two such nutritional food packages 300 encased together. The encasing may be made of a structurally strong, lightweight, attractive, stackable, and disposable material. Suitable examples of such a material may include, but are not limited to, a paper material, a cardboard material, and a plastic material.

In an alternate embodiment of the present invention, a drink bag or a drink pouch may be used for storing the food composition. Such a drink bag or a drink pouch may be made of a structurally strong, lightweight, attractive and disposable material. Suitable examples of such a material may include, but are not limited to, a polymeric material, a cardboard material, and a plastic material.

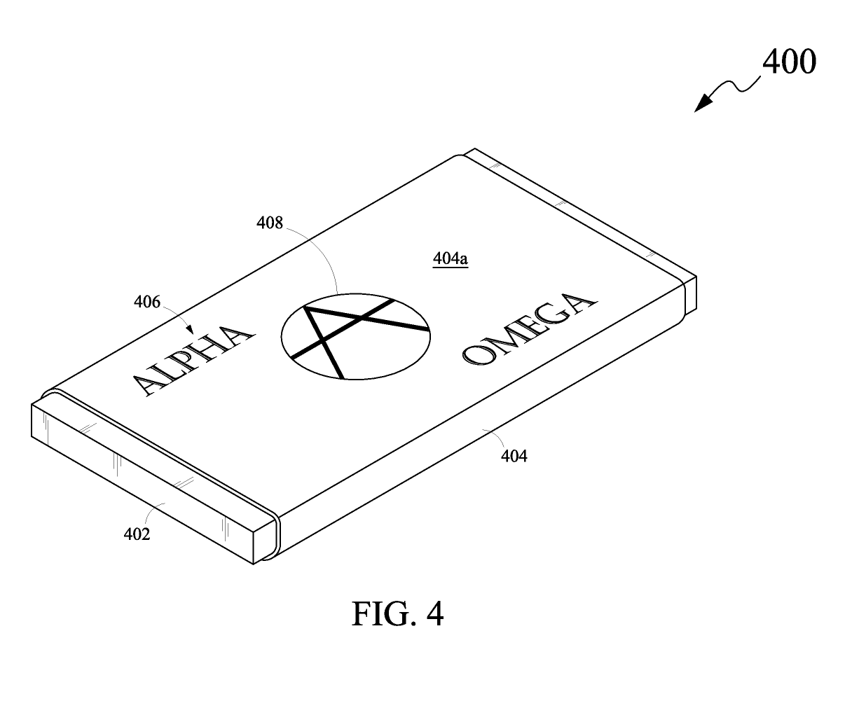

According to another aspect, the food composition of the present invention may be prepared in the form of a food bar instead of a beverage. The food composition of the present invention, which is prepared in the form of a food bar, is explained in conjunction with FIG. 4.

FIG. 4 illustrates a perspective view of a nutritional food package 400 that includes a food composition 402, in the form of a food bar, and an enclosure 404 for storing the food composition 402, according to yet another embodiment of the present invention. For the purpose of this description, the food composition 402 may hereinafter be referred to as a “food bar 402.” The food bar 402 is similar to the food composition 102 of FIG. 1 and the food compositions of FIGS. 2 and 3 in terms of composition with regard to proteins, carbohydrates, vitamins, minerals and trace elements.

The food bar 402 is prepared as a candy bar that includes a soft nugget and a coating on an exterior surface of the soft nugget. Preferably, the coating includes a dark chocolate. Methods that are known in the prior art may be used to prepare the food bar 402 of the present invention. More specifically, the uncooked and the fortified food bar 402 may be prepared by mixing ingredients comprising the aforementioned nutrients or by mixing isolates of the aforementioned nutrients that have been used for preparing the food composition 102. Further, the mixture may be then molded to form the soft nugget. One or more binders that are known in the art may optionally be added while forming the homogeneous mixture. Subsequently, molten dark chocolate may be coated to the exterior surface of the soft nugget.

The food bar 402 may be prepared in any standard or custom size and shape sufficient to be associated with a respective weight of about 4 to about 6 Ounces of the food bar 402, that provides near 100 percent of the daily values of proteins, carbohydrates, vitamins, minerals and trace elements to a consumer. Further, the food bar 402 provides a total of about 2000 calories on consumption.

The nutritional food package 400 may comprise a wrapper as the enclosure 404 of the food bar 402. The wrapper may be prepared in standard or custom sizes and shapes in order to enclose a specific quantity of the food bar 402.

The enclosure 404 of the nutritional food package 400 may include various designs and figures on an outer surface 404a for providing aesthetic appearance or for providing information about contents of the food bar 402. Further, the outer surface 404a may include at least one of a label, a design and a logo to provide an aesthetic appearance to the nutritional food package 400. For the purpose of this description, the outer surface 404a includes a label 406, “ALPHA OMEGA,” imprinted thereon as a representation of the food bar 402. Alternatively, the outer surface 404a may include other labels that help identify contents and advantages of the food bar 402.

Furthermore, the outer surface 404a includes a logo 408 imprinted thereon as a representation of the food bar 402. It should be understood that the logo 408 is similar to the logo 114 of FIG. 1, the logo 218 of FIG. 2 and the logo 312 of FIG. 3 in terms of design, shape and color. It should also be understood that the outer surface 404a may be designed in a similar manner as the outer surface 110 of FIG. 1, the outer surface 206a of FIG. 2 and the outer surface 304a of FIG. 3 in terms of aesthetic appearance. Preferably, the outer surface 404a of the enclosure 404 may be manufactured to have a metallic gold color on which the label 406 and the logo 408 may be represented using a red color.

It should be understood that the enclosure 404 may be manufactured in standard or custom sizes and shapes in order to properly enclose the food bar 402, which is characterized by specific quantity and dimensions thereof. Preferably, the food bar 402 is a brick-shaped food bar. More preferably, the food bar 402 has a length of about 20 centimeters (cm), a width of about 8.50 cm and a thickness of about 1.5 cm. Alternatively, the food bar 402 may have a length of about 20 centimeters (cm), a width of about 9 cm and a height of about 3 cm. The food bar 402 may have a weight greater than about 4 Ounces. According to one embodiment of the present invention, the food bar 402 may be prepared using a concentrate of the aforementioned nutrients, where such a concentrate is reduced to have a weight ranging from about 4 to about 6 Ounces. Specifically, serving size may include three food bars, such as the food bar 402, weighing 471.95 grams (16.65 Ounces), such that, each food bar 402 has a weight of about 5.5 Ounces. According to another embodiment of the present invention, the food bar 402 may have a weight greater than or equal to about 7 Ounces.

Further, the enclosure 404 may be made of a structurally strong, lightweight, attractive, stackable, and disposable material. Examples of such a material that may be used for making the enclosure 404 may include, but are not limited to, a paper material, a cardboard material, a plastic material and a foil, such as an aluminum foil.

It should be apparent to a person skilled in the art that a plurality of nutritional food packages 400 may be encased together as a large pack. Preferably, 12 such nutritional food packages 400 may be encased together to form the large pack. Alternately, 18 such nutritional food packages 400 may be encased together to form the large pack. Further, a single pack may include three such nutritional food packages 400 encased together. The encasing may be made of a structurally strong, lightweight, attractive, stackable, and disposable material. Suitable examples of such a material may include, but are not limited to, a paper material, a cardboard material, and a plastic material.

Various aspects of the present invention provide a nutritional food package that includes an uncooked and a fortified food composition, and an enclosure for storing the food composition. More specifically, the food composition serves as a fortified drink when prepared as a beverage. Alternatively, the food composition serves as a fortified and scrumptious candy bar when prepared as a food bar. The food composition is enriched with non-animal proteins, non-wheat carbohydrates, vitamins, minerals and trace elements; and provides a consumer with near 100 percent of daily values of the aforementioned nutrients. Accordingly, the food composition may serve as a complete nutritious meal substitute. Further, the food composition is a lactose-free composition, a wheat-free composition, a whey-free composition and a nuts-free composition. Accordingly, the food composition provides a balanced nutritional diet, and is capable of providing sustained energy to the consumer. Additionally, the food composition is an uncooked and a fortified food composition that has a fair market value and is a ready-to-consume food composition, which does not require cooking and baking, in order to save time. Moreover, a proper and efficient packaging of the food composition provides an enhanced ease of use thereof to the consumer.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A nutritional food package comprising:
an uncooked and a fortified food composition comprising,
non-animal proteins in an amount of about 10.59 percent by weight of total weight of the food composition,
non-wheat carbohydrates in an amount of about 63.56 percent by weight of the total weight of the food composition,
vitamins, and
minerals and trace elements; and
an enclosure for storing the food composition.

2. The nutritional food package of claim 1, wherein the non-animal proteins comprise one or more soy proteins.

3. The nutritional food package of claim 1, wherein the non-animal proteins comprise one or more rapeseed proteins.

4. The nutritional food package of claim 1, wherein the non-wheat carbohydrates comprise at least one of simple carbohydrates and complex carbohydrates.

5. The nutritional food package of claim 4, wherein the simple carbohydrates are selected from the group consisting of monosaccharides, disaccharides, and combinations thereof.

6. The nutritional food package of claim 4, wherein the complex carbohydrates are selected from the group consisting of oligosaccharides, polysaccharides, and combinations thereof.

7. The nutritional food package of claim 1, wherein the vitamins comprise at least one of vitamin A, vitamin B1, vitamin B2, vitamin B3, vitamin B6, vitamin B5, vitamin B12, biotin, vitamin C, vitamin D, vitamin E and vitamin K.

8. The nutritional food package of claim 1, wherein the minerals comprise at least one of calcium, phosphorus, magnesium, sodium, potassium, and chloride.

9. The nutritional food package of claim 1, wherein the trace elements comprise at least one of iron, chromium, copper, iodine, manganese, selenium, zinc and molybdenum.

10. The nutritional food package of claim 1, wherein the food composition is a lactose-free composition, a whey-free composition and a nuts-free composition.

11. The nutritional food package of claim 1, wherein the food composition is a food bar.

12. The nutritional food package of claim 11, wherein the food bar has a coating of a dark chocolate.

13. The nutritional food package of claim 11, wherein the enclosure is a wrapper.

14. The nutritional food package of claim 1, wherein the food composition is a beverage.

15. The nutritional food package of claim 14, wherein the enclosure is at least one of a bottle, a can, a drink box and a drink bag.
